(19) United States
(12) Patent Application Publication
(10) Pub. No.: US 2018/0293165 A1
(43) Pub. Date: Oct. 11, 2018

(54) GARBAGE COLLECTION BASED ON ASYNCHRONOUSLY COMMUNICATED QUERYABLE VERSIONS

(71) Applicant: HEWLETT PACKARD ENTERPRISE DEVELOPMENT LP, Houston, TX (US)

(72) Inventors: Eden Zik, Cambridge, MA (US); Benjamin M. Vandiver, Arlington, MA (US); Pratyush Parimal, Cambridge, MA (US); Pratibha Rana, Waltham, MA (US); Jason Michael Slaunwhite, Cambridge, MA (US); Shreya Prasad, Cambridge, MA (US); Seyed Amin Saeidi Nyasar, Cambridge, MA (US); Mark Edward Hayden, Cambridge, MA (US)

(21) Appl. No.: 15/482,358

(22) Filed: Apr. 7, 2017

(51) Int. Cl. G06F 12/02; G06F 17/30

(52) U.S. Cl. CPC G06F 12/0253; G06F 2212/1044; G06F 17/30867

(57) ABSTRACT

A technique includes determining an earliest query start time associated with a plurality of queries currently being processed by a node; and based on the identified earliest query start time, selecting a version of a global catalog existing at the earliest start time. The global catalog represents objects stored in a storage shared by the node and at least one other node. The technique includes communicating the selected version of the global catalog to an object garbage collector for the storage.

### BACKGROUND

A database system may include data that is organized in various tables. Each table typically includes one or more rows (also known as tuples or records) that include a set of related data (e.g. related to a single entity). The data for each row may be arranged in a series of columns or fields, wherein each column includes a particular type of data (e.g. type of characteristic of an entity).

A table may contain data that is related to data in another table. For example, in a first table, each row may represent an individual item (e.g. person, object, or event). In a second table, each row may represent a classification group (e.g. organization to which person belongs, places where objects may be located, time periods where events may occur). Tables of a database may be related to one another. For example, a column of the first table may associate each individual item represented there by a reference to one of the classification groups in the second table.

A query to the database may retrieve data that is related in a defined manner from different tables of the database. For example, a query may be expressed in SQL (Structured Query Language) or in another form. A query may be represented as a joining of the tables that are addressed by the query. For example, two tables may be joined by selecting a row of each table that satisfies a criterion (e.g. a particular column value in the row) to form a row in a joined table. In the above example, joining the first and second tables may result, for example, in a joined table in which a row includes a characteristic of an item from the first table together with a characteristic of a group (from the second table) with which that item is associated. In the case of a complex join operation (e.g. where several tables are joined in a sequence of individual join operations) the join operation, and thus the query, may be optimized by modifying an order in which the various individual join operations are executed.

### BRIEF DESCRIPTION OF THE DRAWINGS

FIG. 1 is a schematic diagram of a database system according to an example implementation.

FIG. 2 is an illustration of a process to determine a minimum queryable version (MQV) according to an example implementation.

FIG. 3 is a flow diagram depicting a technique to perform garbage collection of objects stored in shared storage of a database system according to an example implementation.

FIG. 4 is a flow diagram depicting a technique to delete the objects stored in shared storage based on queryable versions of a global catalog according to an example implementation.

FIG. 5 is a flow diagram depicting a technique to delete objects stored in shared storage of a database system in response to failure of a node of the system according to an example implementation.

FIG. 6 is a schematic diagram of a database node according to an example implementation.

FIG. 7 is a flow diagram depicting a technique performed by a database node to determine and communicate an identified version of a global catalog to an object garbage collector according to an example implementation.

FIG. 8 is a schematic diagram of an apparatus containing a plurality of nodes to asynchronously communicate with a garbage collector in a process to delete objects stored by a storage according to an example implementation.

### DETAILED DESCRIPTION

A given database system may have multiple database nodes (computers, workstations, special purpose computers, rack mounted computers, and so forth) and a shared storage. In other words, an object that is stored in the shared storage may be available to multiple database nodes. Having universally addressable objects may complicate the task of purging, or deleting, objects that exceed their lifetimes, in a process called “garbage collection.”

One way to perform garbage collection for a database system that has a shared storage is to frequently synchronize the object states across the nodes for purposes of identifying objects that are no longer in use. However, such an approach may inhibit performance of the database system.

In accordance with example implementations that are described herein, a relaxed, or “lazy,” technique may be utilized to delete objects stored in a shared storage of a database system. More specifically, in accordance with example implementations, the shared storage may store “committed” objects. As used herein, a “committed” object means that all of the nodes of a given cluster of nodes of the database system have acknowledged the parent transaction and as such, have added the object to their respective metadata stores, or “global catalogs.” From that point on, any node in the cluster may refer to the underlying object in a query being processed by the node; and a data object that is referenced by any ongoing query or referenced in the copy of the node's global catalog may not be deleted until the ongoing query completes and the referencing table in the catalog is dropped. An object that is not referenced by an ongoing query by any of the nodes of the cluster or in any node's global catalog copy is considered “dangling” and may be purged, or deleted, by the database system's garbage collector.

For purposes of the garbage collector, determining when to delete a shared object involves knowledge of the reference or references to that object across the cluster. Given a potentially large number (millions, for example) of shared objects, the cost of each node acknowledging its “referenced set” of storage objects may be relatively expensive and as such, may adversely affect the performance of the database system. Moreover, an assumption may not be made that a union of all referenced sets is cumulative. In this manner, unless measures are employed to prevent a query from making progress during deletion by the garbage collector, new and unaccounted for data objects may be created and purged prematurely. In accordance with the garbage collection approach that is described herein, the largest subset of objects that is safe to delete without reducing the overall clusterability is determined, and the garbage collector deletes, or purges, objects in this subset.

More specifically, in accordance with example implementations, each database node of a given cluster stores a copy of a global catalog, which identifies objects that are stored in the shared storage. The global catalog may change with time, and so, different database nodes may store different versions of the global catalog at a given time. These catalog versions are time ordered, such that at any one time, different nodes of the cluster may store a different time ordered version of the global catalog. Moreover, for a given time, a given node may have one or multiple ongoing queries, which, in turn, are associated with one or multiple objects. These ongoing queries, in turn, are associated with time ordered versions of the global catalog. Since the catalog versions are time ordered, for each query, an earliest catalog version associated with the query may be identified. In other words, for each query, all the associated global catalogs may be listed according to respective time orderings, and an earliest catalog version may be selected from this list. Accordingly, the selected catalog version is an earliest global catalog version referencing a time before which there are no queries on the node that reference data objects created at a previous version of the global catalog. This selected version of the global catalog may be referred to as a “Minimum Queryable Version,” or “MQV.” Accordingly, the catalog version at the start time of the earliest ongoing query on the node is the selected MQV.

In accordance with example implementations, the MQVs are communicated, in an asynchronous gossiping process, around the cluster at regular intervals, which allows each node to effectively segment the object space by their expected lifetime. Because, in accordance with example implementations, each data object may be tagged with a version of the global catalog corresponding to the time of the object's deletion, the MQV may be used to identify, or determine, the set of data objects that may still be needed by one of the nodes of the cluster, even if the node(s) are no longer referenced by a table. In this manner, the asynchronous gossiping process disclosed herein allows nodes to remain aware of data objects that are no longer referenced by tables in the present but may be needed by other nodes with ongoing queries started in the past.

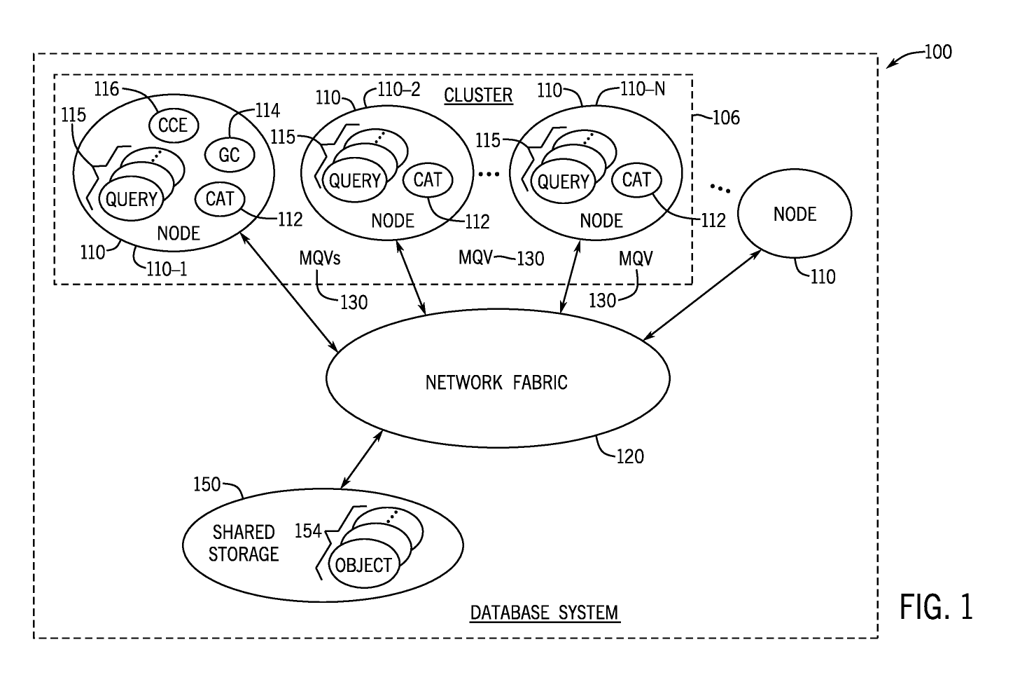

FIG. 1 depicts a database system 100 in accordance with example implementations. The database system 100 includes multiple database nodes, and a given set of the nodes 110 may be effectively grouped together to form a cluster, such as example cluster 106 of FIG. 1. In this manner, the “cluster” refers to a group of the database nodes 110, which collectively process queries for the database system 100. For the example implementation depicted in FIG. 1, N nodes 110 are grouped together to form the example cluster 106. In general, a node 110 refers to a hardware processor-based machine, such as a computer, a workstation, a rack mounted computer, a special purpose computer, and so forth.

As depicted in FIG. 1, the nodes 110 may communicate with each other through network fabric 120 and moreover, via the network fabric 120 may communicate with a storage 150 (called the “shared storage 150” herein), which stores objects 154, which have been committed and stored in the shared storage 150 and may be referenced by multiple nodes 110 of the cluster 106.

Each node 110 may store a global catalog 112 (i.e., a specific copy of a global catalog used by the nodes 110 of the cluster 106) for purposes of referencing the objects 154 stored in the shared storage 150.

A given node 110 of the cluster 106 may have one or multiple ongoing queries 115, which reference tables or objects, which are not visible to other nodes 110 of the cluster 106. For purposes of deleting objects from the shared storage 150 that have exceeded their lifetimes, the database system 100 includes a garbage collector 114, which is schematically depicted in FIG. 1 as being part of the database node 110-1. It is noted, however, that in accordance with further example implementations, the garbage collector 114 may be a distributed engine that is formed by multiple, or all (depending on the particular implementation) nodes 110 of the cluster 106. The garbage collector 114, in general, receives MQVs 130 from the nodes 110 of the cluster 106 and based on the MQVs 130 and the version tags of the objects 154, identifies objects 154 that are no longer in use by any of the nodes 110 in current ongoing queries 115.

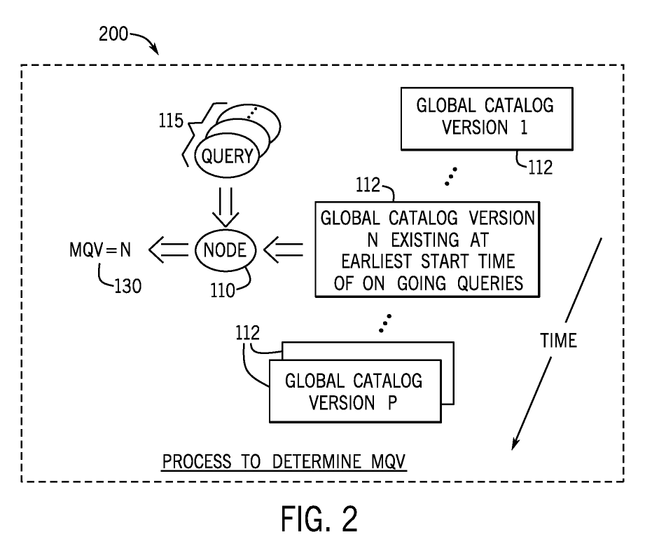

Referring to FIG. 2 in conjunction with FIG. 1, in accordance with example implementations, the global catalog 112 has time ordered versions, which monotonically increase with time. Therefore, in accordance with example implementations, a higher version for the global catalog 112 means that the version was created after a relatively lower version number of the global catalog. FIG. 2 depicts a process 200 to determine the MQV for a given node 110. For this example, a particular version N of the global catalog 112 has an associated time that occurs before the earliest of the ongoing queries 115 currently being processed by the node 110. As such, for this example, the version N forms the MQV for the node 110, and as such, the node 110 may asynchronously communicate an MQV having the version N to the garbage collector 114. Likewise, the other nodes 110 of the cluster 106 may asynchronously communicate their MQVs to the garbage collector 114. By determining the minimum of these MQVs, the garbage collector 114 may select a catalog version to guide the deletion of objects 154 from the shared storage 150.

Thus, in accordance with some implementations, at regular intervals (decoupled from the asynchronous gossip intervals, for example), the garbage collector 114 may delete all data objects 154, whose catalog version is smaller than the minimum of the MQVs 130 in the cluster 106. Given that catalog versions are strictly increasing (i.e., monotonic), no node 110 of the cluster 106 can refer to data objects with earlier catalog versions than the minimum MQV for that the node.

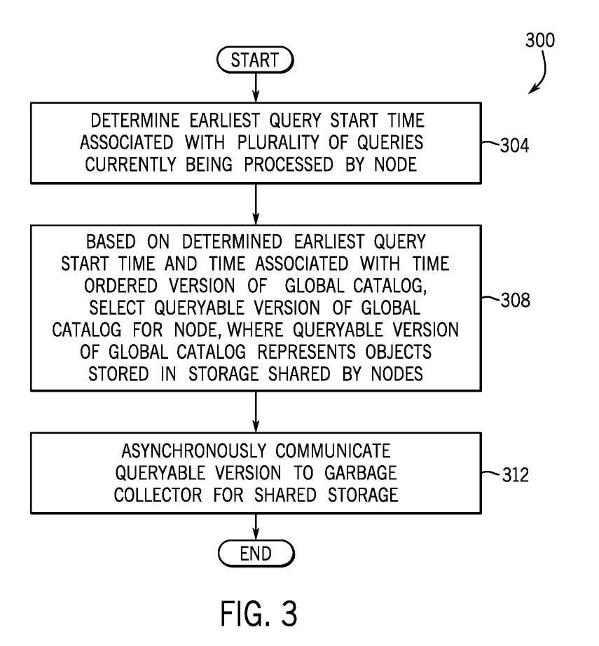

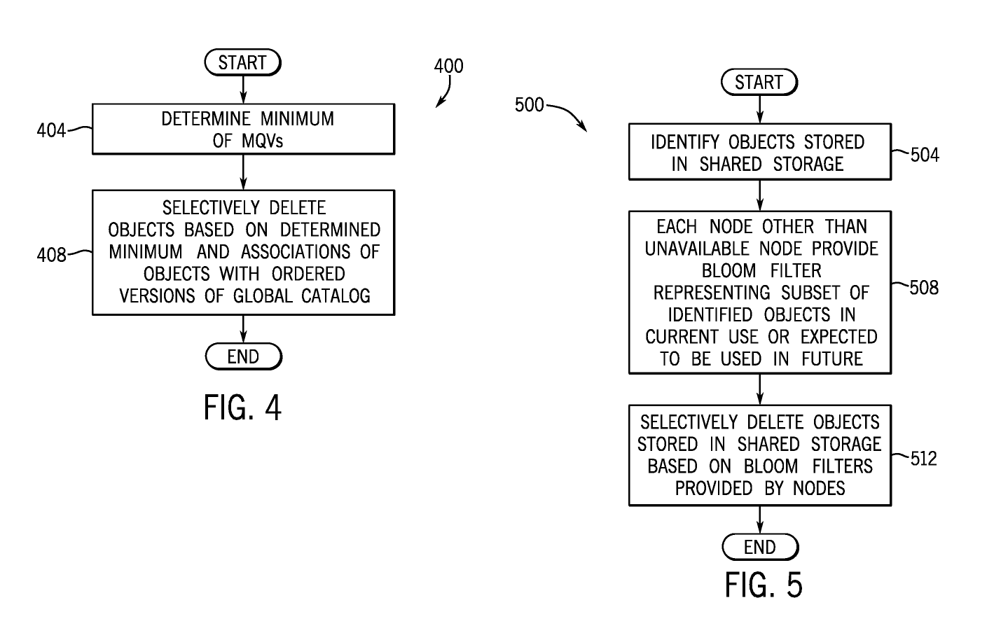

Referring to FIG. 3 in conjunction with FIG. 1, in accordance with example implementations, each node of a plurality of nodes of a distributed database system that contains a shared storage may perform a technique 300. The technique 300 includes determining (block 304) an earliest query start time that is associated with a plurality of queries that are currently being processed by the node. Based on the determined earliest query start time and a time that is associated with a time-ordered version of a global catalog, the node may then select (block 308) a queryable version of the global catalog for the node. The queryable version of the global catalog represents objects that are stored in the shared storage. The technique 300 includes asynchronously communicating (block 312) the minimum queryable version to a garbage collector for the shared storage.

Referring back to FIG. 1, it is entirely possible that a given node 110 of the cluster 106 may go down, or “fail,” during a write of one or multiple objects, but before the objects have been committed to the shared storage 154. In accordance with example implementations, the database system 100 contains a cluster clerk engine 116, which deletes, or purges, temporary files that belong to down nodes. As depicted in FIG. 1, in accordance with some implementations, the cluster clerk engine 116 may be contained in a given node (such as node 110-1 for the example of FIG. 1). However, in accordance with further example implementations, the cluster clerk engine 116 may be a distributed engine that is formed on multiple nodes 110 of the cluster 106. Moreover, in accordance with further example implementations, the cluster clerk engine 116 may be formed on a node other than a database node.

In accordance with example implementations, the cluster clerk engine 116 performs a technique 500 that is depicted in FIG. 5, in response to a node 110 of the cluster 106 failing. Referring to FIG. 5 in conjunction with FIG. 1, in accordance with example implementations, the technique 500 includes the cluster clerk engine 116 identifying all data objects 154 stored on the shared storage 150 (communicating a list to the nodes 110 that have not failed, for example) and requests the non-failed nodes to acknowledge all data objects that are either actively being used or may be expected to be used by the nodes in the future. Pursuant to the technique 500, the non-failed nodes may then provide (block 508) a representation, such as a bloom filter, which represents all data object identifications fitting the criteria requested by the cluster clerk engine 116 in block 504. The cluster clerk engine 116 may then delete the objects 154 in the shared storage 150, pursuant to block 512, as of the time prior to the request, which is not represented in the union of the bloom filters.

In accordance with example implementations, a given database node 110 may not generate/regenerate the bloom filter upon a given request from the cluster clerk engine 116, even amidst the removal of an encoded data object. In this manner, the tolerance for eventual consistency allows the bloom filters to be cached and strictly added to, while disregarding dangling files courtesy of its probabilistic nature.

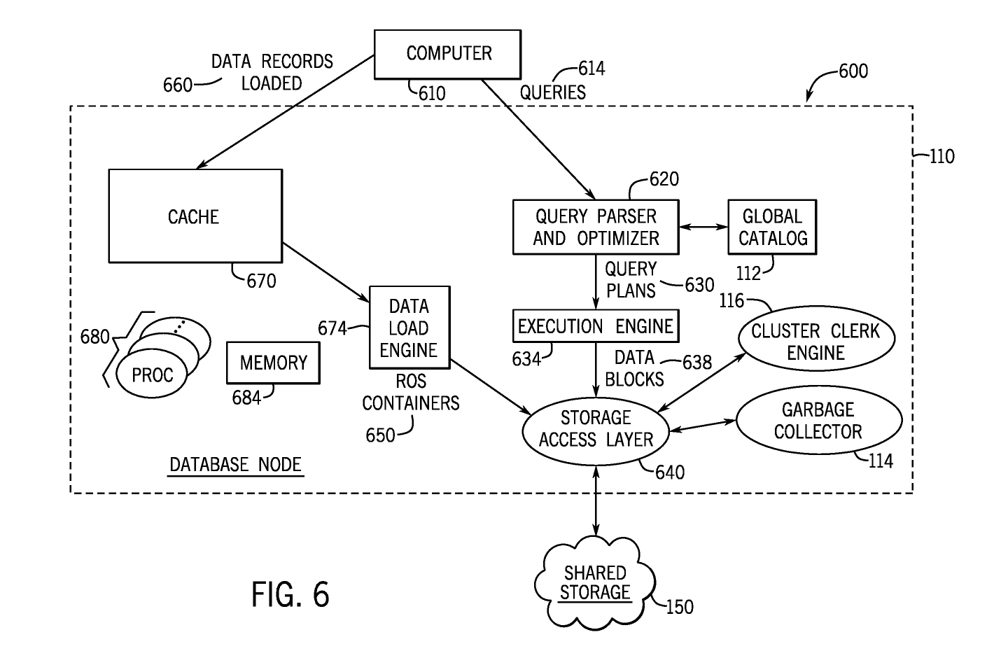

Referring to FIG. 6, in accordance with example implementations, a given database node 110 may operate in an environment 600 as follows. In particular, the database node 110 may receive data representing database operations that are submitted by one or multiple users through, for example, one or multiple computers 610. The computer 610 may communicate with the database system 100 via network fabric (not depicted in FIG. 6). For the example depicted in FIG. 6, the computer 610 may submit one or multiple queries 614 and one or multiple data records 660 in associated load operations to the database system 100.

The queries 614 may be, in accordance with example implementations, parsed by a query parser and optimizer 620 of the node 110. In general, the query parser and optimizer 620 may consult the global catalog 112 to determine the locations of objects (for example, in the shared storage 150), which are referenced by the queries 614. The query parser and optimizer 620 develops a corresponding query plan 630 for a given query 614, which is provided to an execution engine 634 of the node 110. The execution engine 634, in turn, causes a storage access layer 640 of the node 110 to access the shared storage 105 and provide corresponding data blocks 638 back to the execution engine 434 in response to the executed query plan 630.

In accordance with example implementations, the database node 110 may further include a write cache 670 that caches the data records 660 received by the node 110 associated with corresponding data load operations. Moreover, a data load engine 674 of the node 110 may read data from the write cache 670 and rearrange the data into read optimized stored (ROS) containers 650 that are provided to the storage access layer 640 for purposes of storing the ROS containers 650 in the appropriate segments of the shared storage 150.

As also depicted in FIG. 6, the cluster clerk engine 116 and the garbage collector 114 for this example are part of the node 110.

In accordance with example implementations, the node 110 may include one or multiple physical hardware processors 680, such as one or multiple central processing units (CPUs), one or multiple CPU cores, and so forth. Moreover, the database node 110 may include a local memory 684. In general, the local memory 684 is a non-transitory memory that may be formed from, as examples, semiconductor storage devices, phase change storage devices, magnetic storage devices, memristor-based devices, a combination of storage devices associated with multiple storage technologies, and so forth. Regardless of its particular form, the memory 684 may store various data (data representing the global catalog 150, data representing parameters used by the components of the node 110, and so forth) as well as instructions that, when executed by the processor(s) 680, cause the processor(s) 680 to form one or multiple components of the node 110, such as, for example, the query parser and optimizer 620, the execution engine 634, the storage access layer 640, the data load engine 674, the garbage collector 114, the cluster clerk engine 116 and so forth.

In accordance with further example implementations, one or multiple components of the node 110 (such as the garbage collector 114, the cluster clerk engine 116, the execution engine 634, the query parser and optimizer 620, and so forth) may be formed from dedicated hardware that is constructed to perform one or multiple specific functions, such as a field programmable gate array (FPGA), an Application Specific Integrated Circuit (ASIC), and so forth.

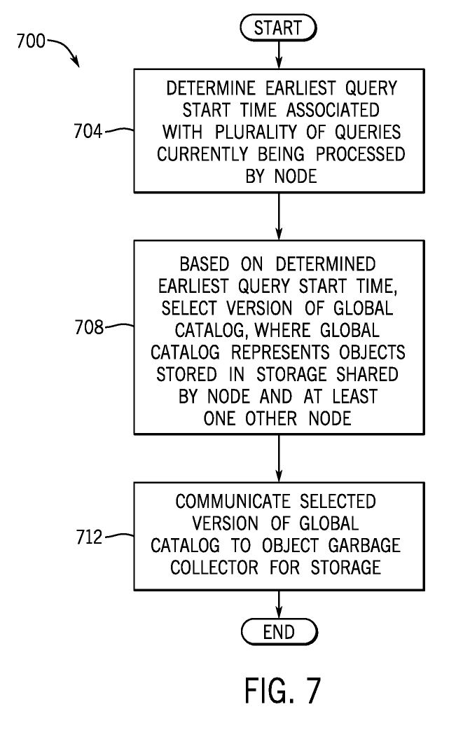

Referring to FIG. 7, in accordance with example implementations, a technique 700 may be performed by a given node (i.e., a given database node 110, for example). The technique 700 includes the node executing instructions to cause the node to determine (block 704) an earliest query start time associated with a plurality of queries that are currently being processed by the node; and, pursuant to block 708, based on the determined earliest query start time, selected a version of a global catalog existing at the earliest start time, where the global catalog represents objects that are stored in a storage that is shared by the node and at least one other node. The technique 700 includes the instructions being executed by the node to cause the node to communicate (block 712) the selected version of the global catalog to an object garbage collector for the storage.

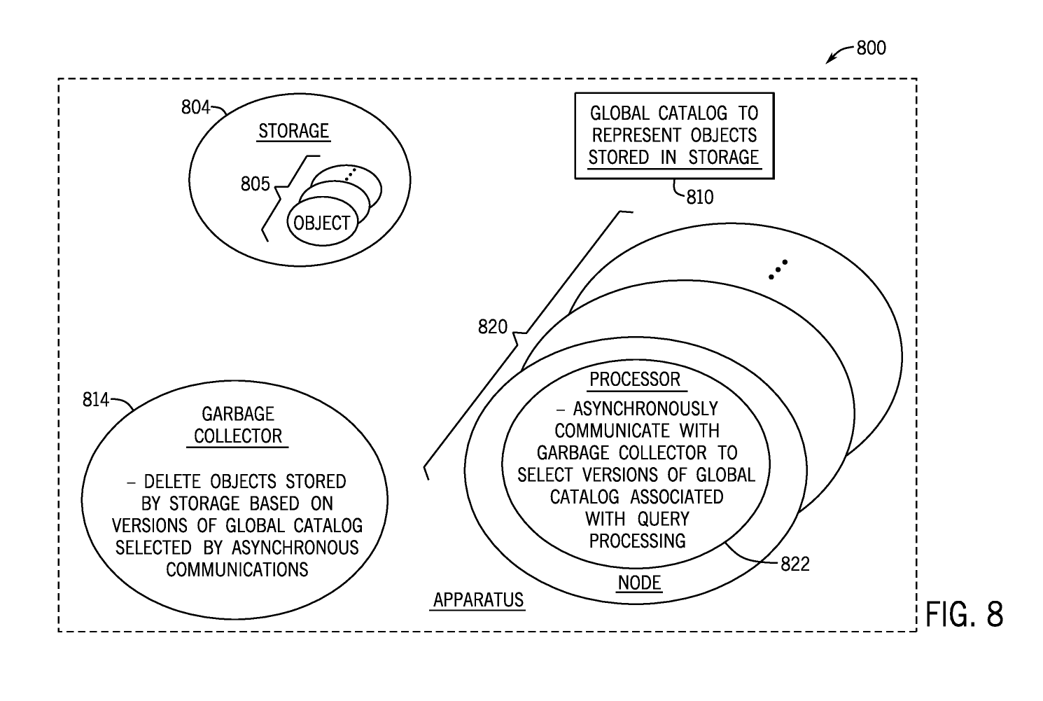

In accordance with further implementations, an apparatus 800 that is depicted in FIG. 8 includes a storage 804 to store objects 805; and a global catalog 810 to represent objects stored in the storage 804. The apparatus 800 includes a plurality of nodes 820, which include hardware processors 822 to asynchronously communicate with the garbage collector 814 to identify time-ordered versions of the global catalog 810 associated with query processing on the nodes 819. The garbage collector 814 deletes the objects 805 stored by the storage 804 based on the versions of the global catalog 810 selected by the asynchronous communications.

Other implementations are contemplated, which are within the scope of the appended claims. For example, in accordance with further example implementations, the object space may be partitioned into multiple partitions; and each node may identify an MQV for each object space partition. In this manner, for a given object space partition, the node may communicate to the garbage collector the MQV for that partition. In other words, in accordance with example implementations, a given node, for each object partition, may asynchronously communicate to the garbage collector the global catalog version that was created or published before or at the same time of the earliest ongoing query that is being processed by the node and involves an object in the object partition. Thus, in accordance with example implementations, each node may maintain a collection of <Partition, MQV> values; and each node may asynchronously communicate its <Partition, MQV> values to the garbage collector. The garbage collector, in turn, may determine the minimum MQV for each object partition, and delete the objects stored in the shared storage that have version tags the same or older than the minimum MQV for each partition. The partitioning of the object space and use of the MQVs in this manner allows the cleanup of objects in some partitions, even in the presence of long running queries accessing other partitions.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
for each node of a plurality of nodes of a distributed database system:
determining an earliest query start time associated with a plurality of queries currently being processed by the node;
based on the determined earliest query start time and the time associated with a time ordered version of a global catalog, selecting a queryable version for the node, wherein the global catalog represents objects stored in a storage shared by the nodes; and
asynchronously communicating the selected queryable version to a garbage collector for the storage.

2. The method of claim 1, wherein the node selecting the queryable version comprises the node identifying the version of the time ordered versions of the global catalog.

3. The method of claim 1, wherein the garbage collector deletes objects in the shared storage that are identified by the selected queryable version.

4. The method of claim 1, wherein a number of ordered versions of the global catalog monotonically increase over time.

5. The method of claim 1, further comprising, in response to a given node of the plurality of nodes failing:
identifying objects stored in the shared storage; and
each node, different from the given node, providing a representation of a subset of the identified objects based on an object usage by the each node.

6. The method of claim 5, wherein identifying the objects stored in the shared storage comprises communicating a list of the objects stored in the shared storage to the each node.

7. The method of claim 5, wherein the representation of the subset is a bloom filter representing the subset.

8. The method of claim 5, wherein the object usage comprises a current usage of objects being processed and a future usage of objects.

9. An article comprising a non-transitory computer readable storage medium storing instructions that when executed by a node cause the node to:
determine an earliest query start time associated with a plurality of queries currently being processed by the node;
based on the determined earliest query start time, select a version of a global catalog existing at the earliest start time, wherein the global catalog represents objects stored in a storage shared by the node and at least one other node; and
communicate the selected version of the global catalog to an object garbage collector for the storage.

10. The article of claim 9, wherein the node comprises a first database node and the plurality of queries currently being processed by the first database node comprises all of the queries currently being processed by the first database node.

11. The article of claim 10, wherein the node and the at least one other node comprise database nodes of a cluster of database nodes, and the storage medium storing instructions that, when executed by the first database node, causes the first database node to store a many-to-many mapping between the nodes of the cluster and versions of the global catalog communicated by the nodes of the cluster.

12. The article of claim 9, wherein the node communicates the selected version of the global catalog asynchronously with respect to a communication of a selected version of the global catalog communicated by the at least one other node.

13. The article of claim 9, wherein:
the instructions when executed by the node cause the node to partition an object space into a plurality of object partitions; and
the instructions when executed by ithe node cause the node to communicate a queryable version for an object partition of the plurality of object partitions to the object garbage collector.

14. An apparatus comprising:
a storage to store objects;
a global catalog to represent objects stored in the storage;
a garbage collector; and
a plurality of nodes comprising hardware processors to asynchronously communicate with the garbage collector to select versions of the global catalog associated with query processing on the nodes,
wherein the garbage collector is to delete the objects stored by the storage based on the versions of the global catalog selected by the asynchronous communications.

15. The apparatus of claim 14, wherein a given node of the plurality of nodes is to:
determine an earliest query start time associated with a plurality of queries currently being processed by the given node; and
based on the determined earliest query start time, select a version of the global catalog existing at the earliest start time.

16. The apparatus of claim 14, wherein the given node is to:
communicate the selected version of the global catalog existing at the earliest start time with the garbage collector.

17. The apparatus of claim 14, wherein the garbage collector is to:
select the earliest of the selected versions of the global catalog existing at the earliest start time; and
delete the objects of the shared storage selected by the selected global catalog.

18. The apparatus of claim 14, wherein a given node of the plurality of nodes comprises the garbage collector.

19. The apparatus of claim 14, further comprising:
a clerk engine to, in response to a given node of the plurality of nodes failing, identify objects of the shared storage,
wherein:
nodes of the plurality of nodes other than the given node are to each provide a representation of a subset of the identified objects being currently used or to be used by the node in the future; and
the garbage collector is to delete objects of the shared storage based on the representations.

20. The apparatus of claim 14, wherein the given node of the plurality of nodes partitioning an object space into a plurality of object spaces and the plurality of queries currently being processed by the given node,
wherein asynchronously communicating the minimum queryable version to the garbage collector comprises asynchronously communicating a minimum queryable version for an object partition of the plurality of object partitions.
